(19) United States
(12) Patent Application Publication
(10) Pub. No.: US 2026/0192241 A1
(43) Pub. Date: Jul. 9, 2026

(54) ACIDIC GAS REMOVAL FROM A POST COMBUSTION PROCESS STREAM

(71) Applicants: PETROLIAM NASIONAL BERHAD (PETRONAS), Kuala Lumpur (MY); DALIAN INSTITUTE OF CHEMICAL PHYSICS, CHINESE ACADEMY OF SCIENCES, Dalian, Liaoning (CN)

(72) Inventors: Siti Hajar Bt KHALIT, Bangsar (MY); Ven Chian QUEK, Jalan Besi Kawi (MY); Khairul B ROSTANI, Putrajaya (MY); Yiming CAO, Dalian, Liaoning (CN); Guodong KANG, Dalian, Liaoning (CN)

(73) Assignees: PETROLIAM NASIONAL BERHAD (PETRONAS), Kuala Lumpur (MY); DALIAN INSTITUTE OF CHEMICAL PHYSICS, CHINESE ACADEMY OF SCIENCES, Dalian, Liaoning (CN)

(21) Appl. No.: 19/134,382

(22) PCT Filed: Nov. 30, 2023
(86) PCT No.: PCT/CN2023/135536

§ 371 Date: May 30, 2025

(30) Foreign Application Priority Data
Nov. 30, 2022 (WO) PCT/CN2022/135236

(51) Int. Cl. B01D 53/22; B01D 53/14; B01D 53/18; C10L 3/10

(52) U.S. Cl. CPC B01D 53/229; B01D 53/1412; B01D 53/1475; B01D 53/18; C10L 3/104; B01D 2053/224; B01D 2257/304; B01D 2257/504; B01D 2258/0283; C10L 2290/44; C10L 2290/541; C10L 2290/548

(57) ABSTRACT

A method for removing acidic gases from a post combustion process stream, the method comprising the steps of: receiving the post combustion process stream into hollow fibres of at least one MBC cell, each hollow fibre gas permeable, liquid impermeable; passing a lean solvent in contact with an external surface of said hollow fibres; exchanging said acidic gas into the solvent through the hollow fibre; venting a treated lean gas stream; exiting an acidic gas rich solvent.

### CROSS-REFERENCE TO RELATED APPLICATION

The present application is a National Stage Application of PCT International Application No.: PCT/CN2023/135536 filed on Nov. 30, 2023, which claims priority to Chinese Patent Application PCT/CN2022/135236, filed on Nov. 30, 2022, and the entire disclosures of both applications are incorporated herein by reference.

### TECHNICAL FIELD

A system and method of removing acidic gas, such as CO₂ and H₂S, from a post combustion process stream.

### BACKGROUND

For clarity, reference to CO₂ will further apply to H₂S and other acidic gases unless the application would make such an extension unworkable.

Process streams, such as for natural gas, maybe high pressure, moderate temperature, high driving force, allowing varied methods of managing acidic gases within the process stream.

However, post-combustion (flue gas), which also requires the removal of CO₂, but at atmospheric pressure and high temperature with low driving force, renders conventional means inefficient or incapable of achieving the desired result, particularly with regard to dealing with the relatively low pressure. Syngas applications, which require both CO₂ and H₂S, may be as low as post-combustion, but generally in between post-combustion and natural gas application's typical operating pressure.

### SUMMARY

A first aspect is a method for removing acidic gases from a post combustion process stream, the method comprising the steps of: receiving the post combustion process stream into hollow fibres of at least one MBC cell, each hollow fibre gas permeable, liquid impermeable; passing a lean solvent in contact with an external surface of said hollow fibres; exchanging said acidic gas into the solvent through the hollow fibre; venting a treated gas lean stream; exiting an acidic gas rich solvent

A second aspect is a gas exchange system, said system comprising: at least one membrane contactor cell; said at least one membrane contactor cell having a bore in which is placed a gas permeable, liquid impermeable, hollow fibre or opposite configuration where liquid is placed in the bore; each hollow fibre having a membrane inlet arranged to receive a gas from an inlet chamber and a membrane outlet for venting said gas; said bore is arranged to flow a lean solvent in contact with an external surface of the hollow fibre so as to permit the exchange of gas through said gas permeable, liquid impermeable membrane, and; a pressure differential control system, said pressure differential control system arranged to monitor a pressure of the post combustion process stream and the lean solvent; wherein said pressure differential control system is arranged to control the solvent and process stream, and maintain a pressure differential whereby the lean solvent pressure is greater than the gas pressure.

The system and method relate to removing acidic gases, such as CO₂ and H₂S, from a post combustion process stream.

By combining membrane and solvent, a membrane contactor system may offer an advantageous way to perform gas-liquid absorption for post combustion gas. The microporous membrane acts as a non-selective phase barrier, allowing the liquid and gas phases to contact with each other, yet without the dispersion of one phase into the other. This barrier prevents flooding or foaming issues from happening, thereby making MBC simple to operate. Packaging into hollow-fiber membrane (HFM) modules offers a higher mass transfer area compared with conventional packed columns, giving MBC a high intensification potential.

It will be appreciated that gas may pass through the fibres and the solvent be in shell and vice versa

### BRIEF DESCRIPTION OF DRAWINGS

It will be convenient to further describe the system and method with respect to the accompanying drawings that illustrate possible arrangements. Other arrangements are possible and consequently, the particularity of the accompanying drawings is not to be understood as superseding the generality of the preceding description.

FIG. 1 is a process flow diagram according to an example embodiment;

FIG. 2 is a process flow diagram according to a further embodiment;

FIGS. 3A to 3C are various cross-sectional views of the fibres in the membrane contactor cell according to a further embodiment;

FIGS. 4A to 4D show various views of a regeneration module according to one embodiment;

FIGS. 5A and 5B are various views of a concentration zone for a module according to a further embodiment;

FIGS. 6A and 6B are various views of a membrane contactor cell according to a further embodiment, and;

FIGS. 7A, 7B and 7C are various views of a membrane contactor cell according to a further embodiment.

### DETAILED DESCRIPTION

In general terms, this patent document involves a system and method for removing acidic gases, such as CO₂ and H₂S, from a post combustion process stream. They may include at least one membrane contactor cell receiving an inflow of flue gas characterised by being low pressure and high temperature. The membrane contactor cell includes a hollow membrane being gas permeable but liquid impermeable or opposite configuration where liquid is placed in the bore. It will be noted that, in one embodiment, the gas may pass through the fibres and the solvent pass through the shell. By passing a lean solvent through the bore of the cell so as to be proximate with the external surface of the membrane, a more efficient exchange of gas will occur. The gas is then vented from the membrane contactor cell, with the now rich solvent flowing out of the cell, potentially for regeneration. It will be appreciated that, even though the system and method are well suited for low pressure regeneration, high pressure regeneration is also possible, at pressures approaching 10 barg.

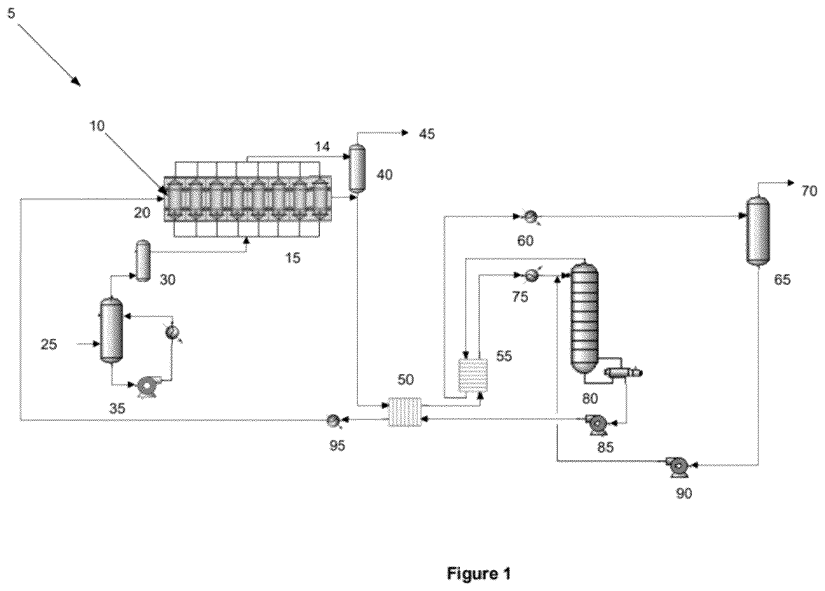

FIG. 1 shows one embodiment of a process flow 5 having an array 15 of membrane contactor cells 10. Flue gas 25 is passed through a quench tower 35 and a filter coalescer 30, then subsequently supplied to the membrane contactor cell (MBC) array 15, as is a lean liquid solvent.

A flue gas or post-combustion gas stream 14 may be fed to a product gas knockout (KO) drum 40 to remove any entrained liquid from the treated gas, and from which the flue gas or post-combustion is vented 45. The now CO₂ rich solvent is passed through cold 50 and hot 55 cross exchanges, which extract CO₂ (and H₂S if the original gas feed is syngas) 60 for subsequent venting 70 from an acid gas KO drum. The remaining solvent is heated 75 and regenerated 80 for reuse 85, 95. The acid gas KO drum is arranged to extract the last of the residual solvent 90, which is fed into the regeneration tower 80.

Thus, the MBC process for treating post combustion gas allows for a low pressure, moderate temperature inflow to have CO₂ separated from the original gas feed. Accompanied with a lean solvent supply and regeneration plant, further enhances the efficiency of the CO₂ extraction.

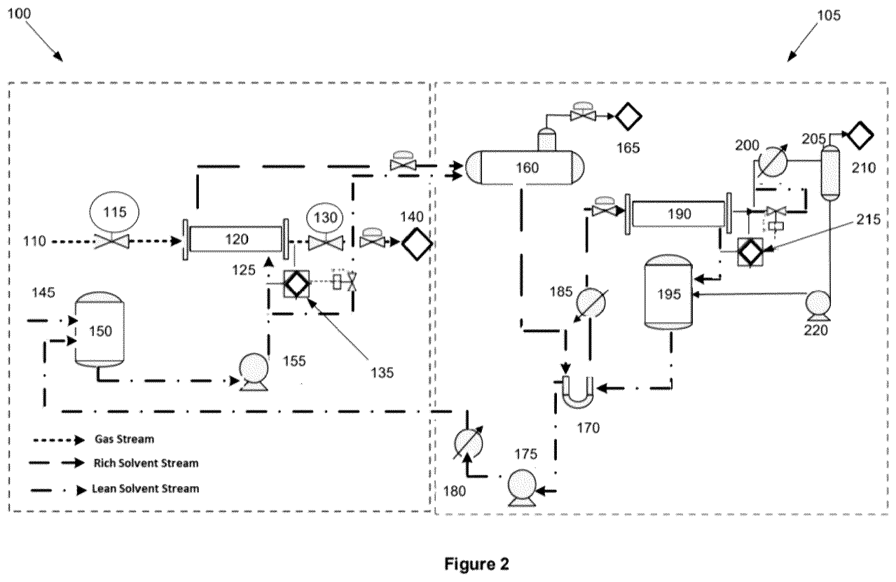

FIG. 2 shows a further embodiment. The process flow diagram of FIG. 2 divides the distinct processes of CO₂ absorption 100 and solvent regeneration 105.

With reference to the absorption process, a syngas having a combination of CO₂ and H₂S or a post combustion gas 110 is directed through a valve 115 into the MBC array 120. The array 120 receives a lean solvent 125, which absorbs CO₂, leaving a syngas (SG) rich gas flow or purified flue gas being fed to a further valve 130 for subsequent venting 140. The now CO₂ rich solvent stream exits the array 120 and is fed into a rich solution flash drum 160. Residual SG gas is extracted and vented to a flash gas system 165.

To maintain appropriate concentrations of solvent within the flash drum 160, parts of a lean solvent stream are also fed into the flash drum 160 with the flash gas removed and the solvent passed to a lean rich exchanger 170. The lean rich exchanger 170 further receives a lean solvent stream from a reflux drum which receives the lean solvent from an MBC array 190 used to extract CO₂ from the rich solvent stream received from the flash drum 160. The gas removed from the rich solvent stream is passed through a condenser 200 and into a flash gas device 210 via a KO drum 205. The gas removed from rich solvent then can be vented or for CO₂ utilisation or CO₂ storage purposes. The residual solvent is then returned 220 to the reflux drum for an exchange through the lean rich exchanger 170. The lean solvent stream is subsequently fed back into the MBC array 120 via an amine tank 150 which further includes a solvent top-up 145.

A characteristic of both of the MBC arrays 120, 190 is the addition of a pressure differential device 135, 215.

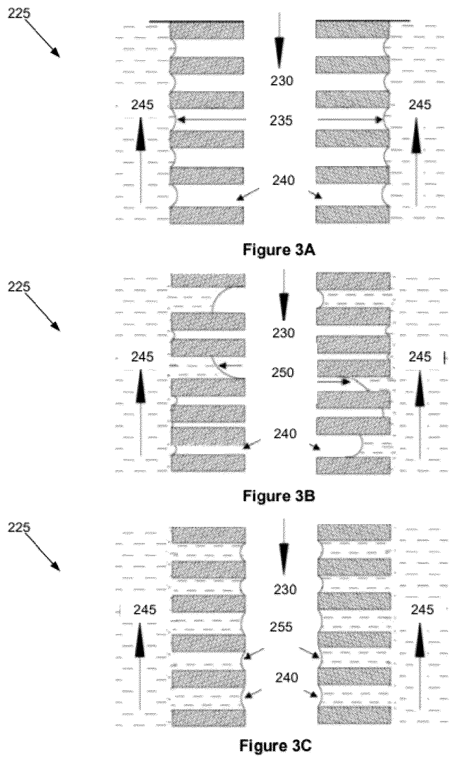

As will be explained with reference to FIGS. 3A to 3C, maintaining a pressure differential between the incoming (treated or outlet) flue gas 110 and the liquid solvent 125, yields significant advantage in terms of efficiency of the process.

FIGS. 3A to 3C show a cross section of a membrane contactor cell 225.

FIG. 3A shows a gas/liquid interface 235 in the circumstance where the pressure differential between the liquid 245 and gas 230 holds the liquid outside the pores 240, and so preventing “wetting” of the gas 230 as it passes through the MBC cell.

If the pressure differential is permitted to increase above certain limit, as shown in FIGS. 3B and 3C, the gas/liquid interface 250, 255 will encroach into the pores, wetting the gas and limiting or preventing the efficient transfer of gas into the solvent that is affected by the pores. Thus, if the pores 240 are flooded by the solvent, the process may stall and may require MBC maintenance.

In one embodiment, the pressure control may maintain the MBC's pressure difference between liquid and gas at 0.3-0.8 bar. In this example, 0.3-0.8 bar may be sufficient to prevent gas bubbling and flooding shown in FIGS. 3B and 3C, and so provide conditions as shown in FIG. 3A.

For this example of post combustion process stream, the set point for the gas and solvent (liquid) may be 0.4 barg and 0.7 barg, respectively. The pressure differential control may be set to maintain a differential pressure between the liquid and gas at 0.3 barg. By having this cascade SP controller, the liquid pressure will always follow the actual gas pressure at MBC to ensure reliable operation and to prevent membrane wetting in the event of high-pressure fluctuations or upset.

Table #1 shows a series of CO₂ experiments were conducted using MBC with CO₂ removal efficiency above >90%.

TABLE #1

| | | | | | | CO₂ |
|---|---|---|---|---|---|---|
| Gas | Liquid | Gas | Liquid | CO₂ | CO₂ | Removal |
| Flowrate | Flowrate | Press | Press | inlet | outlet | Efficiency |
| (kg/h) | (kg/h) | (barg) | (barg) | (mol %) | (mol %) | (%) |
| 0.9 | 1.0 | 0.4 | 0.7 | 2.8 | 0.257 | 90.8 |
| 0.5 | 3.9 | 1.5 | 1.8 | 25 | 0.060 | 99.8 |
| 0.7 | 4.1 | 1.5 | 1.8 | 25 | 0.307 | 98.8 |
| 0.9 | 4.3 | 2.0 | 2.3 | 25 | 1.362 | 94.6 |
| 0.5 | 4.3 | 2.6 | 2.9 | 25 | 0.684 | 97.3 |
| 0.7 | 4.3 | 3.7 | 4.0 | 25 | 0.453 | 98.2 |
| 0.9 | 4.7 | 3.4 | 3.7 | 25 | 1.467 | 94.1 |
| 0.5 | 4.2 | 3.9 | 4.2 | 25 | 0.060 | 99.8 |
| 0.7 | 4.2 | 3.9 | 4.2 | 25 | 0.301 | 98.8 |

Different solvents may be used for flue gas and syngas application due to the difference in gas composition and the removal efficacy (flue gas: CO₂ removal; syngas: CO₂+H₂S removal). The process is mature, but it still has the disadvantages of large volume occupancy, high equipment height, energy intensive and some operation problems such as flooding, channeling, entrainment, and foaming.

One of the reasons why CO₂ removal from post-combustion is energy intensive is because the driving force is low whereby the pressure of the flue gas is at atmospheric pressure. While for syngas, the pressure is between low to medium (up to 50 bar) and with stringent H₂S requirement (<5 ppm) to safeguard the downstream process' catalyst.

The system and method disclosed herein provide a process intensification as the surface area per unit volume may be 30 times more than conventional packed column enabling a reduction in size, energy consumption and cost. They may provide advantages compared to the conventional absorption process, including higher packing density, independent control of gas and absorbent flows, and compact modular structure which provides the flexibility for scale up or down.

In one embodiment, braided PTFE fibers with small pore size may be used in combination with alkanolamines for acid gas removal to improve surface area per unit volume. In addition, multi-cartridge MBC design may have a central tubesheet, or baffle plate, and pressure control.

In an alternative embodiment, the fibres may be hydrophobic. In this embodiment, the hydrophobic fibres resist the full immersion of the solvent that may damage or limit the efficiency of the fibres. Being hydrophobic, the pressure of the liquid may be permitted to exceed that of the gas pressure, within a pre-determined limit controlled by the pressure differential device. For instance, P_{liq} may exceed P_{gas} by 0.3 barg to avoid the degree of encroachment of the liquid which may adversely affect the efficiency and operation of the MBC. In this instance, the immersion of the pores, as shown in FIG. 3B may be permitted without adverse effect. Further, maintaining close control may also permit the degree of immersion shown in FIG. 3C.

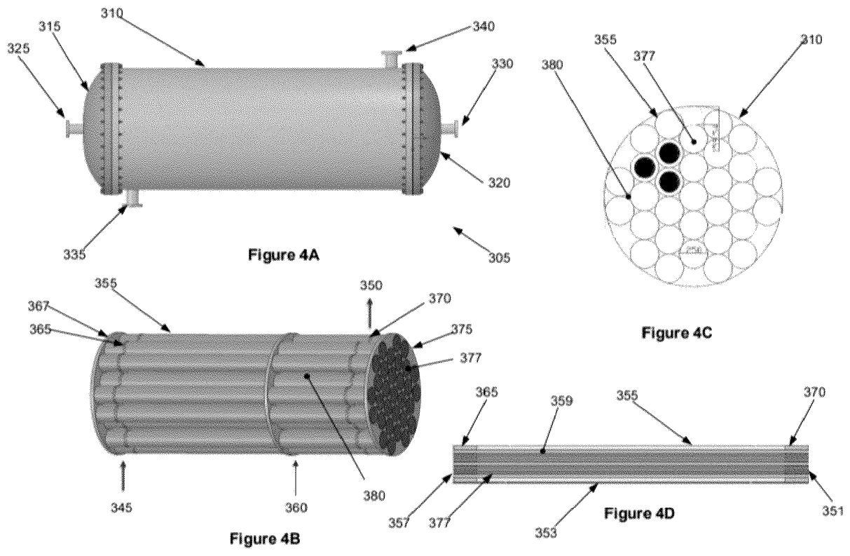

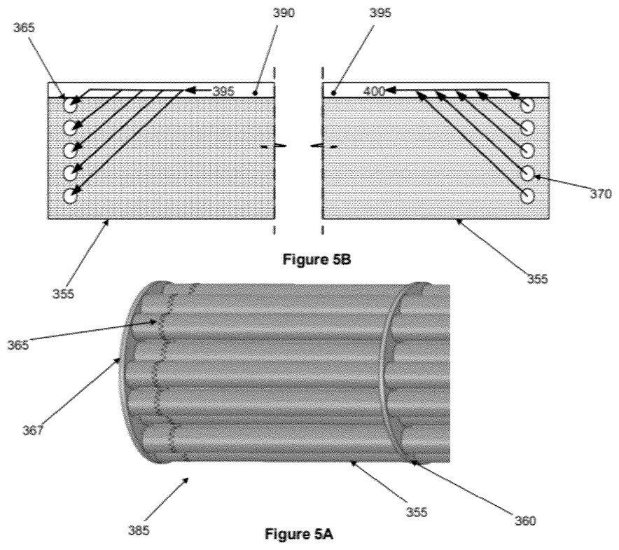

FIGS. 4A to 4D, and FIGS. 5A and 5B, show a membrane contactor module 305 according to an example embodiment.

FIG. 4A shows an elevation view of a module 305 having a housing 310 with end caps 315, 320. The end caps 315, 320 include a gas inlet 325 and a gas outlet 330, respectively. Further, the housing 310 includes an inlet 335 for receiving liquid solvent and outlet 40 for exiting said liquid solvent.

FIGS. 4B and 4C show a plurality of cartridges 355 which are grouped in parallel and held in place by support plates 367, 375. The inlet end cap 315 and inlet support plate 367 define an inlet chamber into which the gas is injected through the inlet 325. Each cartridge 355 includes an open end 357 that permits the flue gas from the inlet chamber to enter into the cartridge 355 and specifically through hollow longitudinal membranes 377. Each cartridge may have one or more membranes located within, depending upon the required flow rate and optimal size of the membrane.

The cartridge 355 further includes interstitial spaces 359 within the bore of the cartridge for receiving solvent, as will be discussed below. The entire cartridge 355 is then sealed around the periphery by a casing 353. The gas is permitted to vent 351 into an outlet chamber defined by outlet support plate 375 and outlet end cap 320 which feed the gas through to the outlet 330.

The solvent enters the housing 310 through the inlet 335 which allows the liquid solvent to flow about the cartridges 355, within an interstitial space 380. The cartridge housing 353, however, prevents direct contact between the solvent within the interstitial space 380 from contacting the membranes 377. The solvent entering 345 the housing 310 is directed to flow into ingress apertures 365 so as to flow through the cartridge 355 within the interstitial space 359 and thus contact with the membrane 377 before exiting the cartridge 355 through ingress apertures 370.

This arrangement provides a fluid path for the solvent that places the solvent in close proximity to the membranes, and so solves the issue of having a sufficient flow for an efficient gas transfer.

In a further embodiment, the baffle plates 360 define concentration zones.

With reference to FIGS. 5A and 5B, the baffle plates 360 define a concentration zone 385 that separates the interstitial spaces 390 near the inlet, ensuring all the solvent flows 395 into the ingress apertures 365 without the solvent escaping directly through the outlet 340. Thus, the use of baffle plates 360 defines a concentration zone 385 that is discrete from the outlet 340, ensuring a flow path for the solvent that is in close proximity to the membranes and thus fully utilizing each of the membranes within the group of cartridges. Once the solvent has flowed through the length of the cartridge 355 it exits from the ingress apertures 370 flowing 400 into the interstitial space 395 proximate to the outlet 340.

It will be appreciated that whilst FIG. 4B shows the position of the baffle plate 360 at approximately two thirds the length of the module 305, in fact the position will be a function of the flow rate 345 into the module 305, the size of the apertures 365, 370 and the desired gas flow rate during the gas transfer within the cartridges. Accordingly, the size of the concentration zone may vary from application to application, subject to various design parameters based upon permeability, flow rate etc.

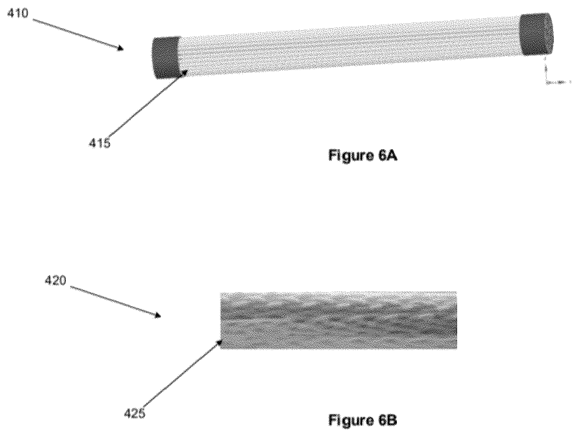

FIGS. 6A and 6B show a further improvement in the MBC cell. Within the cell is a cartridge 410 having a plurality of individual hollow fibres 420, 415, which may be PTFE fibres. In this embodiment, rather than maintaining the hollow fibres in a linear arrangement, the hollow fibres are braided 425 and so providing a greater surface area in which to permit the gas/liquid transfer required of the MBC cell. The form of braiding may take several different arrangements.

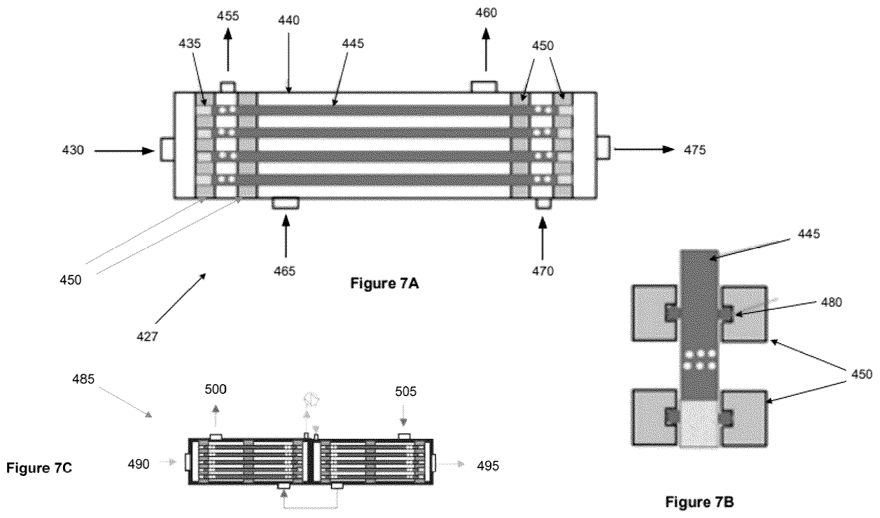

FIGS. 7A and 7B show a further improvement in the MBC cell 427. The cell includes a shell 440, an inlet 430 for introducing the flue gas and outlet 475 for venting the flue gas. Within the cell 427 is a chamber having the cartridges 445, with the chamber divided by two baffle plates 450, where a cooling medium 465 is introduced to exchange heat to maintain a certain temperature range to allow for better CO₂ removal. The cooling medium is subsequently released 460 following the heat transfer. Lean amine solvent 470 is introduced into the chamber to receive the acidic gases, with the rich amine solvent 455 released, allowing the venting 475 of the de-acidified flue gas.

FIG. 7C shows another configuration of a cell 485 where the solvent enters 490 the shell side, and exits 495 at the opposed end, while the flue gas enters 505 the tube side. Solvent will be cooled with an external intercooler and re-enters the second section before exiting 495 as a rich amine solvent.

1. A method for removing acidic gases from a post combustion process stream, the method comprising the steps of:
receiving the post combustion process stream into hollow fibres of at least one MBC cell, each hollow fibre gas permeable, liquid impermeable;
passing a lean solvent in contact with an external surface of said hollow fibres;
exchanging said acidic gas into the solvent through the hollow fibre;
venting a treated gas lean stream;
exiting an acidic gas rich solvent.

2. The method according to claim 1, further including the steps of:
monitoring a pressure of the post combustion process stream;
monitoring a pressure of the lean solvent;
controlling the solvent and/or natural gas stream, and so;
maintaining a pressure differential whereby the solvent pressure is greater than the gas pressure and maintaining optimum solvent temperature for higher CO₂ removal performance.

3. The method according to claim 2, wherein the pressure differential is arranged to prevent the solvent entering pores of the hollow fibres.

4. The method according to claim 1, further including the steps of:
regenerating the acidic gas rich solvent and so;
creating a lean solvent stream, and;
combining the regenerated lean solvent stream with the lean solvent stream.

5. The method according to claim 1, wherein said hollow fibres are braided.

6. A gas exchange system, said system comprising:
at least one membrane contactor cell;
said at least one membrane contactor cell having a bore in which is placed a gas permeable, liquid impermeable, hollow fibre or opposite configuration where liquid is placed in the bore;
each hollow fibre having a membrane inlet arranged to receive a gas from an inlet chamber and a membrane outlet for venting said gas;
said bore is arranged to flow a lean solvent in contact with an external surface of the hollow fibre so as to permit the exchange of gas through said gas permeable, liquid impermeable membrane, and;
a pressure differential control system, said pressure differential control system arranged to monitor a pressure of the post combustion process stream and the lean solvent;
wherein said pressure differential control system is arranged to control the solvent and process stream, and maintain a pressure differential whereby the lean solvent pressure is greater than the gas pressure.

7. The system according to claim 6, wherein the pressure differential is arranged to prevent the solvent entering pores of the hollow fibres.

8. The system according to claim 6, wherein said hollow fibres are braided.

9. The system according to claim 6, further comprising at least two baffle plates, wherein within the cell is a chamber which is divided by at least two of the baffle plates where a cooling medium is introduced to exchange heat to maintain a certain temperature range.
